(19) United States
(12) Patent Application Publication
(10) Pub. No.: US 2026/0077569 A1
(43) Pub. Date: Mar. 19, 2026

(54) SCAVENGER TECHNOLOGY FOR REDUCING EMISSIONS IN GYPSUM PANELS

(71) Applicant: GEORGIA-PACIFIC GYPSUM LLC, Atlanta, GA (US)

(72) Inventor: Sudhanshu Srivastava, Decatur, GA (US)

(21) Appl. No.: 19/108,442

(22) PCT Filed: Sep. 7, 2023
(86) PCT No.: PCT/IB2023/058859

§ 371 Date: Mar. 4, 2025

Related U.S. Application Data
(60) Provisional application No. 63/375,830, filed on Sep. 15, 2022.

(51) Int. Cl. B32B 13/14; B32B 13/02; E04C 2/04

(52) U.S. Cl. CPC B32B 13/14; B32B 13/02; E04C 2/043; B32B 2250/05; B32B 2250/40; B32B 2255/02; B32B 2260/021; B32B 2260/044; B32B 2262/101; B32B 2307/70; B32B 2307/7376; B32B 2419/00; B32B 2607/00

(57) ABSTRACT

Gypsum panels exhibiting decreased formaldehyde emissions, both during and after manufacturing, are disclosed. The gypsum panels comprise a formaldehyde scavenger in at least the slate coat layer. The gypsum panels may optionally comprise a formaldehyde scavenger in one or more other components of the gypsum panel, such as the gypsum core, a face layer, and/or a coating on or in a layer.

### CROSS-REFERENCE TO RELATED APPLICATIONS

This application claims the benefit of U.S. Provisional Application No. 63/375,830, filed Sep. 15, 2022, the contents of which are hereby incorporated by reference in their entirety.

### BACKGROUND

The present invention relates generally to the field of panels for use in building construction, and more particularly to gypsum panels and methods of making gypsum panels.

Typical building panels, such as interior building panels, building sheathing, or roof panels, include a core material, such as gypsum, and a face layer, such as a paper facer or fiberglass mat facer. Formaldehyde (CH₂O) may be emitted by the gypsum core or the face layer, either during manufacturing of the gypsum panels or as a finished product. Formaldehyde is a known irritant and carcinogen in sufficiently high concentrations.

Incorporating formaldehyde scavengers into the gypsum panels has been proposed to reduce CH₂O emissions, but higher levels of the scavengers can degrade the board properties like strength, moisture resistance, and other physical properties. Depending upon the scavenger type used, the scavenger may lead to processing or manufacturing constraints in gypsum board making.

Accordingly, it would be desirable to produce gypsum panels with reduced formaldehyde emissions, both during and after the gypsum panel manufacturing process, without compromising other properties of the gypsum panels.

### BRIEF SUMMARY

Gypsum panels exhibiting decreased formaldehyde emissions, both during manufacturing and as finished products, are provide. Methods of producing such gypsum panels are also provided.

One embodiment is a gypsum panel, said panel comprising:
i) a first face layer;
ii) a second face layer;
iii) a gypsum core layer, interposed between the first face layer and the second face layer; and
iv) a first slate coat layer, interposed between the gypsum core layer and the first face layer;
   wherein at least one slate coat layer comprises a formaldehyde scavenger.

A further embodiment is a method of making a gypsum panel, comprising:
i) providing a slate coat slurry comprising stucco, water, and a formaldehyde scavenger;
ii) providing a face layer; and
iii) setting the slate coat slurry on the face layer to form a slate coat layer of the gypsum panel.

### BRIEF DESCRIPTION OF THE SEVERAL VIEWS OF THE DRAWING(S)

Having thus described the subject matter in general terms, reference will now be made to the accompanying drawings, which are not necessarily drawn to scale.

FIG. 1A is an exemplary diagram of a gypsum panel cross section comprising two slate coat layers.

FIG. 1B is an exemplary diagram of a gypsum panel cross section comprising one slate coat layer.

FIG. 2 is a graph showing curing profiles for gypsum slurries with varying amounts of urea.

### DETAILED DESCRIPTION

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 8-10%, 5.1%-9.9%, and 5.01%-9.99%. Similarly, where a list is presented, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

As used herein, “about” means within a statistically meaningful range of a value or values such as a stated concentration, length, molecular weight, pH, sequence identity, time frame, temperature or volume. Such a value or range can be within an order of magnitude, typically within 20%, more typically within 10%, and even more typically within 5% of a given value or range. The allowable variation encompassed by “about” will depend upon the particular system under study, and can be readily appreciated by one of skill in the art.

As used herein, “formaldehyde scavenger” means any compound that, when included as part of a gypsum panel, reduces the formaldehyde emissions from that gypsum panel either during manufacturing or as a final product. Non-limiting examples include urea, small molecule amine derivatives (organic compounds with a molar mass of 40 to 1000 g/mol), polymers with amine groups, polyurea, polyamines, polymeric alcohols, or starch and other alcohol molecules, inorganic compounds, sodium bisulfite, and activated carbon. A non-limiting example of a polymeric alcohol is polyvinyl alcohol (PVA). A non-limiting class of inorganic compounds is inorganic metal oxides. A non-limiting example of inorganic metal oxide is activated alumina (Al₂O₃).

Gypsum panels and systems of panels, and methods for their manufacture, are provided herein. The panels exhibit decreased formaldehyde release during and after manufacturing, as a final product. In particular, these panels contain a formaldehyde scavenger in at least the slate coat layer, in an amount effective to obtain the desired reduction in formaldehyde emissions, as discussed in detail herein. It has been discovered that the presence of a formaldehyde scavenger in the slate coat may reduce the amount of formaldehyde emissions, without compromising moisture resistance properties of the panel. Further, the gypsum panels may comprise a formaldehyde scavenger in additional layers, such as the gypsum core or the face layer, or in a coating on any layer.

While any gypsum panel may emit formaldehyde, the problem is more severe when the face layer comprises a fiberglass mat. This is because the fiberglass mat may contain certain binder chemistries like urea-formaldehyde, which can disintegrate at high temperatures (such as those used during curing of the gypsum panel) and may release formaldehyde.

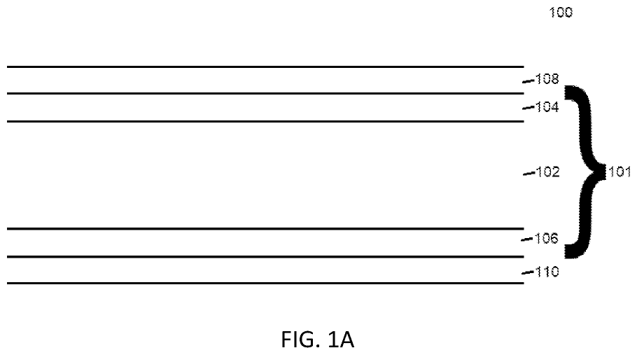

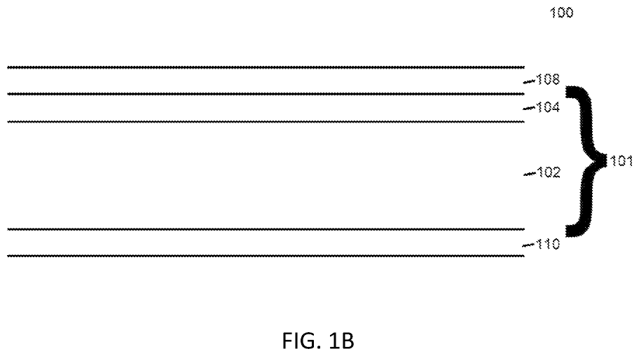

In certain embodiments, as shown in FIG. 1A, a gypsum panel 100 includes a gypsum core 102, and two slate coat layers 104, 106. The second slate coat layer 106 is present on a face of the gypsum core 102 opposite the first slate coat layer 104. The two slate coat layers 104, 106 and the gypsum core 102, collectively, may be referred to as the gypsum layers 101, as the slate coat layers 104, 106 are also made of gypsum. The gypsum panel also comprises two face layers 108, 110 that are associated with the gypsum panel 101. The second face layer 110 is present on a face of the gypsum panel opposite the first face layer 108. In some embodiments, one or both of the face layers 108, 110 may have a coating disposed on one or both surfaces thereof, prior to combination with the gypsum slurry, or, for external surface coatings, after combination with the gypsum slurry. The formaldehyde scavenger may be present in any of these layers, or in a coating adjacent to or between any of these layers, or any individual component of these layers, as discussed in more detail below.

Another embodiment, shown in FIG. 1B, is identical to that depicted in FIG. 1A, but without a second slate coat layer 106. The gypsum core 102 is directly adjacent to the second face layer 110. Thus, the gypsum layers 101 include only the gypsum core 102 and the first slate coat layer 104.

In an embodiment, each slate coat layer has a thickness of about 20-50 mils (1 mil=0.001 inch). In an embodiment, each slate coat layer has a thickness of about 20-40 mils, or about 20-30 mils. In an embodiment, each slate coat layer has a thickness of at least, at most, or about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 mils, or within a range defined by any two of these values.

In an embodiment, each face layer has a thickness of about 10-100 mils. In an embodiment, each face layer has a thickness of about 20-60 mils, or about 20-40 mils. In an embodiment, each face layer has a thickness of at least, at most, or about 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 mils, or within a range defined by any two of these values.

In an embodiment, the core has a thickness of about 150-1000 mils. In an embodiment, the core has a thickness of about 200-950 mils, or about 300-800 mils, or about 400-600 mils. In an embodiment, the core has a thickness of at least, at most, or about 150, 200, 250, 300, 350, 400, 450, 500, 550, 600, 650, 700, 750, 800, 850, 900, 950, or 1000 mils, or within a range defined by any two of these values.

During manufacturing, gypsum slurries are be deposited on the uncoated surface of a face material, such as a paper sheet or fiberglass mat (which may be pre-coated offline or online), and set to form a gypsum core of the panel. The gypsum slurries may adhere to a paper facing material or penetrate some portion of the thickness of the fiberglass mat, and provide a mechanical bond for the panel. In an embodiment, there are three gypsum slurry layers applied, in order, to form the embodiment depicted in FIG. 1A: 1) a first slate coat slurry; 2) a gypsum core layer slurry; and 3) a second slate coat slurry. In an embodiment, the first and the second slate coat slurries are identical. In an embodiment, there are two gypsum slurry layers applied, in order, to form the embodiment depicted in FIG. 1B: 1) a first slate coat slurry; and 2) a gypsum core layer slurry. Following the deposition of the gypsum slurry layers, a second face layer is laid on top of the slurries, prior to curing.

As used herein, the term “slate coat” refers to a gypsum slurry having a higher wet density than the remainder of the gypsum slurry that forms the gypsum core. In some embodiments, the slate coat is formed from a slurry which lacks a foaming agent, but is otherwise identical to the slurry used to form the gypsum core. In some embodiments, the slate coat is formed from a slurry which lacks a foaming agent, and comprises a formaldehyde scavenger, but is otherwise identical to the slurry used to form the gypsum core.

While this disclosure is generally directed to gypsum panels, it should be understood that other cementitious panel core materials are also intended to fall within the scope of the present disclosure. For example, cementitious panel core materials such as those including magnesium oxide or aluminosilicate may be substituted for the gypsum of the embodiments disclosed herein, to achieve similar results.

Moreover, while embodiments of the present disclosure are described generally with reference to paper facing materials or fiberglass mats as the face layer, it should be understood that other mat materials, including other fibrous mat materials, may also be used in the present panels. In certain embodiments, the nonwoven fibrous mat is formed of fiber material that is capable of forming a strong bond with the material of the building panel core through a mechanical-like interlocking between the interstices of the fibrous mat and portions of the core material. Examples of fiber materials for use in the nonwoven mats include mineral-type materials such as glass fibers, synthetic resin fibers, and mixtures or blends thereof. Both chopped strands and continuous strands may be used.

### Methods and Compositions

Methods of making gypsum panels containing formaldehyde scavengers are provided. In particular, these methods may include forming a slate coat gypsum slurry by combining stucco, water, and a formaldehyde scavenger, and setting the slate coat slurry to form a slate coat layer of said gypsum panel.

The formaldehyde scavenger is present in at least one slate coat layer or slurry. For example, the formaldehyde scavenger may be present in at least one slate coat layer or slurry in an amount of about 0.5 lb/msf to about 50 lb/msf, for a gypsum panel having a thickness of about ¼ inch to about 1 inch. For example, the formaldehyde scavenger may be present in at least one slate coat layer or slurry in an amount of about 1 lb/msf to about 40 lb/msf, for a gypsum panel having a thickness of about ¼ inch to about 1 inch. For example, the formaldehyde scavenger may be present in at least one slate coat layer or slurry in an amount of about 1 lb/msf to about 35 lb/msf, such as in an amount of about 1 lb/msf to about 30 lb/msf, about 1 lb/msf to about 25 lb/msf, about 1 lb/msf to about 20 lb/msf, or about 1 lb/msf to about 10 lb/msf, for a gypsum panel having a thickness of about ¼ inch to about 1 inch.

In embodiments, the formaldehyde scavenger may be present in at least one slate coat layer or slurry in an amount of less than, greater than, or about 0.5 lb/msf, about 0.6 lb/msf, about 0.7 lb/msf, about 0.8, lb/msf, about 0.91b/msf, 1 lb/msf, about 2 lb/msf, about 3 lb/msf, about 4 lb/msf, about 5 lb/msf, about 6 lb/msf, about 7 lb/msf, about 8 lb/msf, about 9 lb/msf, about 10 lb/msf, about 11 lb/msf, about 12 lb/msf, about 13 lb/msf, about 14 lb/msf, about 15 lb/msf, about 16 lb/msf, about 17 lb/msf, about 18 lb/msf, about 19 lb/msf, about 20 lb/msf, about 21 lb/msf, about 22 lb/msf, about 23 lb/msf, about 24 lb/msf, about 25 lb/msf, about 26 lb/msf, about 27 lb/msf, about 28 lb/msf, about 29 lb/msf, about 30 lb/msf, about 31 lb/msf, about 32 lb/msf, about 33 lb/msf, about 34 lb/msf, about 35 lb/msf, about 36 lb/msf, about 37 lb/msf, about 38 lb/msf, about 39 lb/msf, about 40 lb/msf, about 41 lb/msf, about 42 lb/msf, about 43 lb/msf, about 44 lb/msf, about 45 lb/msf, about 46 lb/msf, about 47 lb/msf, about 48 lb/msf, about 49 lb/msf, or about 50 lb/msf, for a gypsum panel having a thickness of about ¼ inch to about 1 inch.

As used herein, “msf” refers to 1,000 square feet.

The panel thickness ranges given herein are meant to be exemplary, and it should be understood that panels in accordance with the present disclosure may have any suitable thickness. Where amounts of materials present within the panel are defined in terms of lb/msf over a certain thickness of panel, it should be understood that the amount of the relevant material described to be present per area of the panel may be applied to various other panel thicknesses. In certain embodiments, the panels have a thickness from about ¼ inch to about 1 inch. For example, the panels may have a thickness of from about ½ inch to about ¾ inch, such as from about ½ inch to about ⅝ inch, as generally described.

These methods may be used to produce gypsum panels having reduced formaldehyde emissions, as described herein. In certain embodiments, the gypsum panel comprising a formaldehyde scavenger emits from about 1% to about 99% fewer formaldehyde emissions, as compared to an otherwise identical panel that does not comprise the formaldehyde scavenger, as measured by any method described herein. In certain embodiments, the gypsum panel comprising a formaldehyde scavenger emits at least or about 1%, 2%, 5%, 10%, 15%, 20%, 25%, 30%, 35%, 40%, 45%, 50%, 55%, 60%, 65%, 70%, 75%, 80%, 85%, 90%, 95%, or 99% fewer formaldehyde emissions, as compared to an otherwise identical panel that does not comprise the formaldehyde scavenger, as measured by any method described herein.

In certain embodiments, the formaldehyde scavenger is present in both slate coat layers or slurries. In an embodiment, the first slate coat layer or slurry and the second slate coat layer or slurry comprise a formaldehyde scavenger in identical concentrations. In an embodiment, the first slate coat layer or slurry and the second slate coat layer or slurry comprise a formaldehyde scavenger in different concentrations. In an embodiment, the first slate coat layer or slurry and the second slate coat layer or slurry comprise the same formaldehyde scavenger. In an embodiment, the first slate coat layer or slurry and the second slate coat layer or slurry comprise different formaldehyde scavengers.

In certain embodiments, the formaldehyde scavenger is also present in the gypsum core layer or slurry in addition to the slate coat. For example, the formaldehyde scavenger may be present in the gypsum core layer or slurry in an amount of about 1 lb/msf to about 80 lb/msf, for a gypsum panel having a thickness of about ¼ inch to about 1 inch. In certain embodiments, the formaldehyde scavenger is present in the gypsum core layer or slurry in an amount of about 10 lb/msf to about 40 lb/msf, for a gypsum panel having a thickness of about ¼ inch to about 1 inch. In certain embodiments, the formaldehyde scavenger is present in the gypsum core layer or slurry in an amount of about 10 lb/msf to about 35 lb/msf, such as in an amount of about 10 lb/msf to about 30 lb/msf, about 15 lb/msf to about 25 lb/msf, or about 15 lb/msf to about 20 lb/msf, for a gypsum panel having a thickness of about ¼ inch to about 1 inch.

In embodiments, the formaldehyde scavenger is present in the gypsum core layer or slurry in an amount of less than, greater than, or about 1 lb/msf, about 2 lb/msf, about 3 lb/msf, about 4 lb/msf, about 5 lb/msf, about 6 lb/msf, about 7 lb/msf, about 8 lb/msf, about 9 lb/msf, about 10 lb/msf, about 11 lb/msf, about 12 lb/msf, about 13 lb/msf, about 14 lb/msf, about 15 lb/msf, about 16 lb/msf, about 17 lb/msf, about 18 lb/msf, about 19 lb/msf, about 20 lb/msf, about 21 lb/msf, about 22 lb/msf, about 23 lb/msf, about 24 lb/msf, about 25 lb/msf, about 26 lb/msf, about 27 lb/msf, about 28 lb/msf, about 29 lb/msf, about 30 lb/msf, about 31 lb/msf, about 32 lb/msf, about 33 lb/msf, about 34 lb/msf, about 35 lb/msf, about 36 lb/msf, about 37 lb/msf, about 38 lb/msf, about 39 lb/msf, about 40 lb/msf, about 41 lb/msf, about 42 lb/msf, about 43 lb/msf, about 44 lb/msf, about 45 lb/msf, about 46 lb/msf, about 47 lb/msf, about 48 lb/msf, about 49 lb/msf, about 50 lb/msf, about 51 lb/msf, about 52 lb/msf, about 53 lb/msf, about 54 lb/msf, about 55 lb/msf, about 56 lb/msf, about 57 lb/msf, about 58 lb/msf, about 59 lb/msf, about 60 lb/msf, about 61 lb/msf, about 62 lb/msf, about 63 lb/msf, about 64 lb/msf, about 65 lb/msf, about 66 lb/msf, about 67 lb/msf, about 68 lb/msf, about 69 lb/msf, about 70 lb/msf, about 71 lb/msf, about 72 lb/msf, about 73 lb/msf, about 74 lb/msf, about 75 lb/msf, about 76 lb/msf, about 77 lb/msf, about 78 lb/msf, about 79 lb/msf, or about 80 lb/msf, for a gypsum panel having a thickness of about ¼ inch to about 1 inch, or within a range defined by any two of these values.

In certain embodiments, the formaldehyde scavenger can be distributed through the core layer (0.04 to 5% by board weight or 1 lb/msf to 80 lb/msf, for a gypsum panel having a thickness of about ¼ inch to about 1 inch) and at least one slate coat layer (0.02 to 3% by board weight or 0.5 lb/msf to 50 lb/msf, for a gypsum panel having a thickness of about ¼ inch to about 1 inch) such that the ratio of the concentration of formaldehyde scavenger in the at least one slate layer to the concentration in the gypsum core layer is from 1.1:1 to 3:1, as measured either by board weight percent or lb/msf. In an embodiment, the ratio is 1.5:1 to 2.5:1. In an embodiment, the ratio is 1.8:1 to 2.2:1. In an alternative embodiment, embodiment, the ratio of the concentration of formaldehyde scavenger in the at least one slate layer to the concentration in the gypsum core layer is from 1:1.1 to 1:6. In an embodiment, the ratio is 1:1.5 to 1:3. In an embodiment, the ratio is 1:1.8 to 1:2.2.

In certain embodiments, a formaldehyde scavenger is also present in at least one face layer in addition to being in a slate coat.

In certain embodiments, wherein the formaldehyde scavenger is in the slate coat layer (0.02 to 3% by board weight or 0.5 lb/msf to 50 lb/msf, for a gypsum panel having a thickness of about ¼ inch to about 1 inch), face layer glass mat (0.0004 to 3% by board weight or 0.01 lb/msf to 50 lb/msf, for a gypsum panel having a thickness of about ¼ inch to about 1 inch) and core (0.04 to 5% by board weight or 1 lb/msf to 80 lb/msf, for a gypsum panel having a thickness of about ¼ inch to about 1 inch), the formaldehyde scavenger can be distributed through core, at least one slate and at least one face layer such that the concentration of formaldehyde scavenger is characterized by [concentration in slate layer]>[concentration in face layer]>[concentration in core layer], as measured either by board weight percent or lb/msf. In another embodiment, the formaldehyde scavenger can be distributed through core, slate and face layers such the concentration of formaldehyde scavenger is characterized by [concentration in face layer]>[concentration in slate layer]>[concentration in core layer]. In another embodiment, the concentration of formaldehyde scavenger is characterized by [concentration in slate layer]>[concentration in core layer]>[concentration in face layer].

In another embodiment, the concentration of formaldehyde scavenger is characterized by [concentration in face layer]>[concentration in core layer]>[concentration in slate layer]. In another embodiment, the concentration of formaldehyde scavenger is characterized by [concentration in core layer]>[concentration in face layer]>[concentration in slate layer]. In another embodiment, the concentration of formaldehyde scavenger is characterized by [concentration in core layer]>[concentration in slate layer]>[concentration in face layer].

In certain embodiments, the face layer is a glass mat; said glass mat comprising
i) glass fibers;
ii) a resin binder; and/or
iii) a mat coating;
wherein the formaldehyde scavenger is present in said resin binder and/or said mat coating.

In certain embodiments, said resin binder is a urea-formaldehyde resin. In certain embodiments, said resin binder is a phenol/formaldehyde resin. In certain embodiments, said resin binder is a melamine/formaldehyde resin. In certain embodiments, said resin binder is a formaldehyde-free resin.

The face layers can be sprayed using 40 to 60% by weight formaldehyde scavenger solution or can also be dipped in the solution of 10 to 40% by weight formaldehyde scavenger solution. In embodiments, the solutions are aqueous solutions. Once sprayed or dipped in solution, the face layer can be applied to the slate coat slurry. In an embodiment, the face layer is applied as a dry or wet glass mat. Once panel assembly is complete, the panel is dried in an oven to remove the moisture.

In certain embodiments, the formaldehyde scavenger is present in at least one face layer in an amount of about 0.5 lb/msf to about 50 lb/msf, for a gypsum panel having a thickness of about ¼ inch to about 1 inch. In certain embodiments, the formaldehyde scavenger is present in at least one face layer in an amount of about 1 lb/msf to about 40 lb/msf, for a gypsum panel having a thickness of about ¼ inch to about 1 inch. For example, the formaldehyde scavenger is present in at least one face layer in an amount of about 1 lb/msf to about 35 lb/msf, such as in an amount of about 10 lb/msf to about 30 lb/msf, about 1 lb/msf to about 25 lb/msf, about 1 lb/msf to about 20 lb/msf, or about 1 lb/msf to about 10 lb/msf, for a gypsum panel having a thickness of about ¼ inch to about 1 inch.

In embodiments, the formaldehyde scavenger is present in at least one face layer in an amount of less than, greater than, or about 0.5 lb/msf, about 0.6 lb/msf, about 0.7 lb/msf, about 0.8, lb/msf, about 0.91b/msf, 1 lb/msf, about 2 lb/msf, about 3 lb/msf, about 4 lb/msf, about 5 lb/msf, about 6 lb/msf, about 7 lb/msf, about 8 lb/msf, about 9 lb/msf, about 10 lb/msf, about 11 lb/msf, about 12 lb/msf, about 13 lb/msf, about 14 lb/msf, about 15 lb/msf, about 16 lb/msf, about 17 lb/msf, about 18 lb/msf, about 19 lb/msf, about 20 lb/msf, about 21 lb/msf, about 22 lb/msf, about 23 lb/msf, about 24 lb/msf, about 25 lb/msf, about 26 lb/msf, about 27 lb/msf, about 28 lb/msf, about 29 lb/msf, about 30 lb/msf, about 31 lb/msf, about 32 lb/msf, about 33 lb/msf, about 34 lb/msf, about 35 lb/msf, about 36 lb/msf, about 37 lb/msf, about 38 lb/msf, about 39 lb/msf, about 40 lb/msf, about 41 lb/msf, about 42 lb/msf, about 43 lb/msf, about 44 lb/msf, about 45 lb/msf, about 46 lb/msf, about 47 lb/msf, about 48 lb/msf, about 49 lb/msf, or about 50 lb/msf, for a gypsum panel having a thickness of about ¼ inch to about 1 inch, or within a range defined by any two of these values.

In embodiments comprising a first face layer and a second face layer, the face layers do not need to be identical. For example, in an embodiment where both face layers are glass mats, one glass mat may have a binder comprising formaldehyde, while the other glass mat may comprise a formaldehyde-free binder. The components and concentrations thereof in each of the face layers are independent of each other.

In certain embodiments, said gypsum panel comprises a coating on an exterior surface of at least one of said face layers; wherein said exterior coating comprises a formaldehyde scavenger.

In certain embodiments, the formaldehyde scavenger is present in the exterior coating in an amount of about 0.01 lb/msf to about 10 lb/msf, or about 0.1 lb/msf to about 5 lb/msf. or about 1 lb/msf to about 2 lb/msf, for a gypsum panel having a thickness of about % inch to about 1 inch. In embodiments, the formaldehyde scavenger is present in the exterior coating in an amount of less than, greater than, or about 0.01 lb/msf, about 0.05 lb/msf, about 0.1 lb/msf, about 0.2 lb/msf, about 0.3 lb/msf, about 0.4 lb/msf, about 0.5 lb/msf, about 0.6 lb/msf, about 0.7 lb/msf, about 0.8 lb/msf, about 0.9 lb/msf, about 1 lb/msf, about 2 lb/msf, about 3 lb/msf, about 4 lb/msf, about 5 lb/msf, about 6 lb/msf, about 7 lb/msf, about 8 lb/msf, about 9 lb/msf, or about 10 lb/msf, for a gypsum panel having a thickness of about ¼ inch to about 1 inch, or within a range defined by any two of these values.

In certain embodiments, wherein at least one of said face layers and said gypsum core layer or slurry comprise a formaldehyde scavenger, said at least one of said face layers and said gypsum core or slurry comprise said formaldehyde scavenger in a concentration which is the same as the concentration of formaldehyde scavenger in said slate coat layer or slurry. In an alternative embodiment, said at least one of said face layers and said gypsum core layer or comprise said formaldehyde scavenger in a concentration which is less than or greater than the concentration of formaldehyde scavenger in said slate coat layer.

In an embodiment, said at least one of said face layers and said gypsum core or slurry comprise said formaldehyde scavenger in a concentration which is less than about 5% to less than about 99% of the concentration of formaldehyde scavenger in said slate coat layer or slurry. In certain embodiments, said at least one of said face layers and said gypsum core or slurry comprise said formaldehyde scavenger in a concentration which is less than or about 5%, 10%, 15%, 20%, 25%, 30%, 35%, 40%, 45%, 50%, 55%, 60%, 65%, 70%, 75%, 80%, 85%, 90%, or 95% of the concentration of formaldehyde scavenger in said slate coat layer or slurry.

In embodiments, gypsum slurries are prepared with water to stucco ratio in ratios of 100 parts of stucco to 50-100 parts of water. A formaldehyde scavenger solution can be prepared between 30 to 80% by weight by dilution in water, prior to adding to the slate coat slurry. Alternatively, the formaldehyde scavenger, as powder, can be added directly in the slate coat slurry or core slurry.

In certain embodiments, the gypsum slurries of the present disclosure, used to form the gypsum core or the slate coat layers, further contain one or more ingredients or additives to achieve the desired board properties. Various additives are discussed herein and may be used in any combination. In particular, suitable additives may include, but are not limited to, one or more of starch, fiberglass, dispersants, ball mill accelerators, retarders, potash, polyphosphates, and polymer binders. In certain embodiments, the gypsum core can be free of formaldehyde scavenger.

For example, a suitable polyphosphate may be contained in a gypsum slurry. For example, the polyphosphate may be sodium trimetaphosphate (STMP), sodium hexametaphosphate (SHMP), ammonium polyphosphate (APP). Other suitable phosphate salts may also be used and include other metaphosphate, polyphosphate, and pyrophosphate salts, such as ammonium trimetaphosphate, potassium trimetaphosphate, lithium trimetaphosphate, calcium trimetaphosphate, sodium calcium trimetaphosphate, aluminum trimetaphosphate; ammonium, lithium, or potassium hexametaphosphates; sodium tripolyphosphate, potassium tripolyphosphate, sodium and potassium tripolyphosphate; calcium pyrophosphate, tetrapotassium pyrophosphate, and/or tetrasodium pyrophosphate.

In certain embodiments, a starch is present in the relevant gypsum layer or slurry in an amount of about 0.01 percent to about 1.5 percent, by weight. In certain embodiments, the starch is present in the relevant gypsum layer or slurry in an amount of about 0.1 percent to about 0.5 percent, by weight. In some embodiments, the starch is present in the relevant gypsum layer or slurry in an amount of about 0.05 percent to about 0.2 percent, by weight. In some embodiments, the starch is present in the relevant gypsum layer or slurry in an amount of about 1 lb/msf to about 50 lb/msf, for a gypsum panel having a thickness of about ¼ inch to about 1 inch. In some embodiments, the starch is present in the relevant gypsum layer or slurry in an amount of less than, greater than, or about 1 lb/msf, about 2 lb/msf, about 3 lb/msf, about 4 lb/msf, about 5 lb/msf, about 6 lb/msf, about 7 lb/msf, about 8 lb/msf, about 9 lb/msf, about 10 lb/msf, about 11 lb/msf, about 12 lb/msf, about 13 lb/msf, about 14 lb/msf, about 15 lb/msf, about 16 lb/msf, about 17 lb/msf, about 18 lb/msf, about 19 lb/msf, about 20 lb/msf, about 21 lb/msf, about 22 lb/msf, about 23 lb/msf, about 24 lb/msf, about 25 lb/msf, about 26 lb/msf, about 27 lb/msf, about 28 lb/msf, about 29 lb/msf, about 30 lb/msf, about 31 lb/msf, about 32 lb/msf, about 33 lb/msf, about 34 lb/msf, about 35 lb/msf, about 36 lb/msf, about 37 lb/msf, about 38 lb/msf, about 39 lb/msf, about 40 lb/msf, about 41 lb/msf, about 42 lb/msf, about 43 lb/msf, about 44 lb/msf, about 45 lb/msf, about 46 lb/msf, about 47 lb/msf, about 48 lb/msf, about 49 lb/msf, about 50 lb/msf, about 51 lb/msf, about 52 lb/msf, about 53 lb/msf, about 54 lb/msf, about 55 lb/msf, about 56 lb/msf, about 57 lb/msf, about 58 lb/msf, about 59 lb/msf, about 60 lb/msf, about 61 lb/msf, about 62 lb/msf, about 63 lb/msf, about 64 lb/msf, about 65 lb/msf, about 66 lb/msf, about 67 lb/msf, about 68 lb/msf, about 69 lb/msf, or about 70 lb/msf, for a gypsum panel having a thickness of about ¼ inch to about 1 inch, or within a range defined by any two of these values.

In certain embodiments, a polyphosphate is present in the relevant gypsum layer or slurry in an amount of about 0.01 percent to about 1 percent, by weight. In certain embodiments, the polyphosphate is present in the relevant gypsum layer or slurry in an amount of about 0.01 percent to about 0.5 percent, by weight. In some embodiments, the polyphosphate is present in the relevant gypsum layer or slurry in an amount of about 0.05 percent to about 0.2 percent, by weight. In some embodiments, the polyphosphate is present in the relevant gypsum layer or slurry in an amount of about 1 lb/msf to about 50 lb/msf, for a gypsum panel having a thickness of about ¼ inch to about 1 inch. In some embodiments, the polyphosphate is present in the relevant gypsum layer or slurry in an amount of less than, greater than, or about 1 lb/msf, about 2 lb/msf, about 3 lb/msf, about 4 lb/msf, about 5 lb/msf, about 6 lb/msf, about 7 lb/msf, about 8 lb/msf, about 9 lb/msf, about 10 lb/msf, about 11 lb/msf, about 12 lb/msf, about 13 lb/msf, about 14 lb/msf, about 15 lb/msf, about 16 lb/msf, about 17 lb/msf, about 18 lb/msf, about 19 lb/msf, about 20 lb/msf, about 21 lb/msf, about 22 lb/msf, about 23 lb/msf, about 24 lb/msf, about 25 lb/msf, about 26 lb/msf, about 27 lb/msf, about 28 lb/msf, about 29 lb/msf, about 30 lb/msf, about 31 lb/msf, about 32 lb/msf, about 33 lb/msf, about 34 lb/msf, about 35 lb/msf, about 36 lb/msf, about 37 lb/msf, about 38 lb/msf, about 39 lb/msf, about 40 lb/msf, about 41 lb/msf, about 42 lb/msf, about 43 lb/msf, about 44 lb/msf, about 45 lb/msf, about 46 lb/msf, about 47 lb/msf, about 48 lb/msf, about 49 lb/msf, or about 50 lb/msf, for a gypsum panel having a thickness of about ¼ inch to about 1 inch, or within a range defined by any two of these values.

For example, a suitable polymer binder, such as an organic polymer binder may be contained in a gypsum slurry. Suitable polymer binders may include polymeric emulsions and resins, e.g., acrylics, siloxane, silicone, styrene-butadiene copolymers, polyethylene-vinyl acetate, polyvinyl alcohol, polyvinyl chloride (PVC), polyurethane, urea-formaldehyde resin, phenolics resin, polyvinyl butyryl, styrene-acrylic copolymers, styrene-vinyl-acrylic copolymers, styrene-maleic anhydride copolymers. In some embodiments, the binders may include UV curable monomers and polymers (e.g., epoxy acrylate, urethane acrylate, polyester acrylate). For example, on a dry basis, the polymer binder content in the relevant gypsum layer or slurry may be between 1 lb/msf to 50 lb/msf, for a gypsum panel having a thickness of about ¼ inch to 1 inch.

In certain embodiments, a polymer binder is present in the relevant gypsum layer or slurry in an amount of about 0.01 percent to about 1 percent, by weight. In certain embodiments, the polymer binder is present in the relevant gypsum layer or slurry in an amount of about 0.01 percent to about 0.5 percent, by weight. In some embodiments, the polymer binder is present in the relevant gypsum layer or slurry in an amount of about 0.05 percent to about 0.2 percent, by weight. In some embodiments, the polymer binder is present in the relevant gypsum layer or slurry in an amount of about 1 lb/msf to about 50 lb/msf, for a gypsum panel having a thickness of about ¼ inch to about 1 inch. In some embodiments, the polymer binder is present in the relevant gypsum layer or slurry in an amount of less than, greater than, or about 1 lb/msf, about 2 lb/msf, about 3 lb/msf, about 4 lb/msf, about 5 lb/msf, about 6 lb/msf, about 7 lb/msf, about 8 lb/msf, about 9 lb/msf, about 10 lb/msf, about 11 lb/msf, about 12 lb/msf, about 13 lb/msf, about 14 lb/msf, about 15 lb/msf, about 16 lb/msf, about 17 lb/msf, about 18 lb/msf, about 19 lb/msf, about 20 lb/msf, about 21 lb/msf, about 22 lb/msf, about 23 lb/msf, about 24 lb/msf, about 25 lb/msf, about 26 lb/msf, about 27 lb/msf, about 28 lb/msf, about 29 lb/msf, about 30 lb/msf, about 31 lb/msf, about 32 lb/msf, about 33 lb/msf, about 34 lb/msf, about 35 lb/msf, about 36 lb/msf, about 37 lb/msf, about 38 lb/msf, about 39 lb/msf, about 40 lb/msf, about 41 lb/msf, about 42 lb/msf, about 43 lb/msf, about 44 lb/msf, about 45 lb/msf, about 46 lb/msf, about 47 lb/msf, about 48 lb/msf, about 49 lb/msf, or about 50 lb/msf, for a gypsum panel having a thickness of about ¼ inch to about 1 inch, or within a range defined by any two of these values.

In certain embodiments, each of the slate coat layers is deposited in an amount of from about 5 percent to about 20 percent, by weight, of the gypsum layers. This would mean that the gypsum core layer comprises about 80 to about 95 percent of the total weight of the gypsum layers, when one slate coat layer is present, and about 60 to about 90 percent of the total weight of the gypsum layers, when two slate coat layers are present. The gypsum slurries may be deposited by any suitable means, such as roll coating.

In certain embodiments, a gypsum layer or slurry contains one or more additional agents to enhance its performance, such as, but not limited to, wetting agents, moisture resistance agents, fillers, accelerators, set retarders, foaming agents, polyphosphates, and dispersing agents. Various example uses of such further additives will now be described.

In certain embodiments, a wetting agent is selected from a group consisting of surfactants, superplasticisers, dispersants, agents containing surfactants, agents containing superplasticisers, agents containing dispersants, and combinations thereof. For example, suitable superplasticisers include Melflux 2651F and 4930F, commercially available from BASF Corporation. In certain embodiments, the wetting agent is a surfactant having a boiling point of 200° C. or lower. In some embodiments, the surfactant has a boiling point of 150° C. or lower. In some embodiments, the surfactant has a boiling point of 110° C. or lower. For example, the surfactant may be a multifunctional agent based on acetylenic chemistry or an ethoxylated low-foam agent.

In certain embodiments, a surfactant is present in the relevant gypsum layer or slurry in an amount of about 0.01 percent to about 1 percent, by weight. In certain embodiments, the surfactant is present in the relevant gypsum layer or slurry in an amount of about 0.01 percent to about 0.5 percent, by weight. In some embodiments, the surfactant is present in the relevant gypsum layer or slurry in an amount of about 0.05 percent to about 0.2 percent, by weight. In some embodiments, the surfactant is present in the relevant gypsum layer or slurry in an amount of about 1 lb/msf to about 50 lb/msf, for a gypsum panel having a thickness of about ¼ inch to about 1 inch. In some embodiments, the surfactant is present in the relevant gypsum layer or slurry in an amount of less than, greater than, or about 1 lb/msf, about 2 lb/msf, about 3 lb/msf, about 4 lb/msf, about 5 lb/msf, about 6 lb/msf, about 7 lb/msf, about 8 lb/msf, about 9 lb/msf, about 10 lb/msf, about 11 lb/msf, about 12 lb/msf, about 13 lb/msf, about 14 lb/msf, about 15 lb/msf, about 16 lb/msf, about 17 lb/msf, about 18 lb/msf, about 19 lb/msf, about 20 lb/msf, about 21 lb/msf, about 22 lb/msf, about 23 lb/msf, about 24 lb/msf, about 25 lb/msf, about 26 lb/msf, about 27 lb/msf, about 28 lb/msf, about 29 lb/msf, about 30 lb/msf, about 31 lb/msf, about 32 lb/msf, about 33 lb/msf, about 34 lb/msf, about 35 lb/msf, about 36 lb/msf, about 37 lb/msf, about 38 lb/msf, about 39 lb/msf, about 40 lb/msf, about 41 lb/msf, about 42 lb/msf, about 43 lb/msf, about 44 lb/msf, about 45 lb/msf, about 46 lb/msf, about 47 lb/msf, about 48 lb/msf, about 49 lb/msf, or about 50 lb/msf, for a gypsum panel having a thickness of about ¼ inch to about 1 inch, or within a range defined by any two of these values.

Suitable surfactants and other wetting agents may be selected from non-ionic, anionic, cationic, or zwitterionic compounds, such as alkyl sulfates, ammonium lauryl sulfate, sodium lauryl sulfate, alkyl-ether sulfates, sodium laureth sulfate, sodium myreth sulfate, docusates, dioctyl sodium sulfosuccinate, perfluorooctanesulfonate, perfluorobutanesulfonate, linear alkylbenzene sulfonates, alkyl-aryl ether phosphates, alkyl ether phosphate, alkyl carboxylates, sodium stearate, sodium lauroyl sarcosinate, carboxylate-based fluorosurfactants, perfluorononanoate, perfluorooctanoate, amines, octenidine dihydrochloride, alkyltrimethylammonium salts, cetyl trimethylammonium bromide, cetyl trimethylammonium chloride, cetylpyridinium chloride, benzalkonium chloride, benzethonium chloride, 5-Bromo-5-nitro-1,3-dioxane, dimethyldioctadecylammonium chloride, cetrimonium bromide, dioctadecyldimethylammonium bromide, sultaines, cocamidopropyl hydroxysultaine, betaines, cocamidopropyl betaine, phospholipids phosphatidylserine, phosphatidylethanolamine, phosphatidylcholine, sphingomyelins, fatty alcohols, cetyl alcohol, stearyl alcohol, cetostearyl alcohol, stearyl alcohols. oleyl alcohol, polyoxyethylene glycol alkyl ethers, octaethylene glycol monododecyl ether, pentaethylene glycol monododecyl ether, polyoxypropylene glycol alkyl ethers, glucoside alkyl ethers, polyoxyethylene glycol octylphenol ethers, polyoxyethylene glycol alkylphenol ethers, glycerol alkyl esters, polyoxyethylene glycol sorbitan alkyl esters, sorbitan alkyl esters, cocamide MEA, cocamide DEA, dodecyldimethylamine oxide, polyethoxylated tallow amine, and block copolymers of polyethylene glycol and polypropylene glycol. For example, suitable surfactants include Surfynol 61, commercially available from Air Products and Chemicals, Inc. (Allentown, PA).

In certain embodiments, a moisture resistance or hydrophobizing agent is provided in the gypsum slurry or layers thereof to impart desired moisture resistance and/or processing properties to the panel. For example, the moisture resistance or hydrophobizing agent may include a wax, wax emulsions or co-emulsions, silicone, siloxane, siliconate, or any combination thereof. In certain embodiments, a moisture resistance or hydrophobizing agent is present in the relevant gypsum layer or slurry in an amount of about 0.01 percent to about 1 percent, by weight. In certain embodiments, the moisture resistance or hydrophobizing agent is present in the relevant gypsum layer or slurry in an amount of about 0.01 percent to about 0.5 percent, by weight. In some embodiments, the moisture resistance or hydrophobizing agent is present in the relevant gypsum layer or slurry in an amount of about 0.05 percent to about 0.2 percent, by weight. In some embodiments, the moisture resistance or hydrophobizing agent is present in the relevant gypsum layer or slurry in an amount of about 1 lb/msf to about 50 lb/msf, for a gypsum panel having a thickness of about ¼ inch to about 1 inch. In some embodiments, the moisture resistance or hydrophobizing agent is present in the relevant gypsum layer or slurry in an amount of less than, greater than, or about 1 lb/msf, about 2 lb/msf, about 3 lb/msf, about 4 lb/msf, about 5 lb/msf, about 6 lb/msf, about 7 lb/msf, about 8 lb/msf, about 9 lb/msf, about 10 lb/msf, about 11 lb/msf, about 12 lb/msf, about 13 lb/msf, about 14 lb/msf, about 15 lb/msf, about 16 lb/msf, about 17 lb/msf, about 18 lb/msf, about 19 lb/msf, about 20 lb/msf, about 21 lb/msf, about 22 lb/msf, about 23 lb/msf, about 24 lb/msf, about 25 lb/msf, about 26 lb/msf, about 27 lb/msf, about 28 lb/msf, about 29 lb/msf, about 30 lb/msf, about 31 lb/msf, about 32 lb/msf, about 33 lb/msf, about 34 lb/msf, about 35 lb/msf, about 36 lb/msf, about 37 lb/msf, about 38 lb/msf, about 39 lb/msf, about 40 lb/msf, about 41 lb/msf, about 42 lb/msf, about 43 lb/msf, about 44 lb/msf, about 45 lb/msf, about 46 lb/msf, about 47 lb/msf, about 48 lb/msf, about 49 lb/msf, or about 50 lb/msf, for a gypsum panel having a thickness of about ¼ inch to about 1 inch, or within a range defined by any two of these values.

In certain embodiments, the gypsum slurry (or one or more layers thereof) is substantially free of foam, honeycomb, excess water, and micelle formations. As used herein, the term “substantially free” refers to the slurry containing lower than an amount of these materials that would materially affect the performance of the panel. That is, these materials are not present in the slurry in an amount that would result in the formation of pathways for liquid water in the glass mat of a set panel, when under pressure.

In certain embodiments, a gypsum slurry layer, and particularly a slate coat layer, may be deposited on a horizontally oriented moving web of facer material, such as pre-coated fibrous mat or paper facing material. A second coated or uncoated web of facer material may be deposited onto the surface of the gypsum slurries (particularly a second slate coat slurry) opposite the first web of facer material, e.g., a non-coated surface of the second web of facer material contacts the gypsum slurry layer. In some embodiments, a moving web of a facer material may be placed on the upper free surface of the gypsum slurry. Thus, the gypsum layers may be sandwiched between two facer materials, none, one or both having a coating. In certain embodiments, allowing the gypsum layer slurries and/or coating to set includes curing, drying, such as in an oven or by another suitable drying mechanism, or allowing the material(s) to set at room temperature (i.e., to self-harden).

A barrier coating may be applied to both face layers, prior to or after drying of the face layers. In some embodiments, the glass mats are pre-coated when they are associated with the slate coat slurry. In some embodiments, depositing a barrier coating onto the second surface of the first coated face layer occurs after setting the first gypsum slurry to form a slate core layer. In some embodiments, the slate coat layer coated with the barrier coating is cured, dried, such as in an oven or by another suitable drying mechanism, or the materials are allowed to set at room temperature. In some embodiments, infrared heating is used to flash off water and dry the barrier coating.

Suitable coating materials (i.e., the precursor to the dried mat coating) may contain at least one suitable polymer binder. Suitable polymer binders may be selected from polymeric emulsions and resins, e.g. acrylics, siloxane, silicone, styrene-butadiene copolymers, polyethylene-vinyl acetate, polyvinyl alcohol, polyvinyl chloride (PVC), polyurethane, urea-formaldehyde resin, phenolics resin, polyvinyl butyryl, styrene-acrylic copolymers, styrene-vinyl-acrylic copolymers, styrene-maleic anhydride copolymers. In some embodiments, the polymer binder is an acrylic latex or a polystyrene latex. In some embodiments, the polymer binder is hydrophobic. In certain embodiments, the binder includes UV curable monomers and/or polymers (e.g. epoxy acrylate, urethane acrylate, polyester acrylate). In certain embodiments, the mat coating contains the polymer binder in an amount of from about 5 percent to about 75 percent, by weight, on a dry basis.

Examples of suitable polymer binders that may be used in the continuous barrier coatings described herein include SNAP 720, commercially available from Arkema Coating Resins, which is a structured nano-particle acrylic polymer containing 100% acrylic latex and 49% solids by weight, with a 0.08 micron particle size; SNAP 728, commercially available from Arkema Coating Resins, which is a structured nano-acrylic polymer containing 100% acrylic latex and 49% solids by weight, with a 0.1 micron particle size; and NEOCAR 820, commercially available from Arkema Coating Resins, which is a hydrophobic modified acrylic latex containing 45% solids by weight, with a 0.07 micron particle size.

In certain embodiments, the mat coating also contains one or more inorganic fillers. For example, the inorganic filler may be calcium carbonate or another suitable filler known in the industry. In certain embodiments, the filler is an inorganic mineral filler, such as ground limestone (calcium carbonate), clay, mica, gypsum (calcium sulfate dihydrate), aluminum trihydrate (ATH), antimony oxide, sodium-potassium alumina silicates, pyrophyllite, microcrystalline silica, and talc (magnesium silicate). In certain embodiments, the filler may inherently contain a naturally occurring inorganic adhesive binder. For example, the filler may be limestone containing quicklime (CaO), clay containing calcium silicate, sand containing calcium silicate, aluminum trihydrate containing aluminum hydroxide, cementitious fly ash, or magnesium oxide containing either the sulfate or chloride of magnesium, or both. In certain embodiments, the filler may include an inorganic adhesive binder as a constituent, cure by hydration, and act as a flame suppressant. For example, the filler may be aluminum trihydrate (ATH), calcium sulfate (gypsum), and the oxychloride and oxysulfate of magnesium. For example, fillers may include MINEX 7, commercially available from the Cary Company (Addison, IL); IMSIL A-10, commercially available from the Cary Company; and TALCRON MP 44-26, commercially available from Specialty Minerals Inc. (Dillon, MT). The filler may be in a particulate form. For example, the filler may have a particle size such that at least 95% of the particles pass through a 100 mesh wire screen.

In certain embodiments, the precursor material that forms the mat coating also contains water. For example, the coating material may contain the polymer binder in an amount of from about 35 percent to about 80 percent, by weight, and water in an amount of from about 20 percent to about 30 percent, by weight. In embodiments containing the filler, the continuous barrier coating material may also contain an inorganic filler in an amount of from about 35 percent to about 80 percent, by weight. In some embodiments, the polymer binder and the inorganic filler are present in amounts of within 5 percent, by weight, of each other. For example, the polymer binder and filler may be present in a ratio of approximately 1:1.

In some embodiments, the mat coating also includes water and/or other optional ingredients such as colorants (e.g., dyes or pigments), transfer agents, thickeners or rheological control agents, surfactants, ammonia compositions, defoamers, dispersants, biocides, UV absorbers, and preservatives. Thickeners may include hydroxyethyl cellulose; hydrophobically modified ethylene oxide urethane; processed attapulgite, a hydrated magnesium aluminosilicate; and other thickeners known to those of ordinary skill in the art. For example, thickeners may include CELLOSIZE QP-09-L and ACRYSOL RM-2020NPR, commercially available from Dow Chemical Company (Philadelphia, Pa.); and ATTAGEL 50, commercially available from BASF Corporation (Florham Park, N.J.). Surfactants may include sodium polyacrylate dispersants, ethoxylated nonionic compounds, and other surfactants known to those of ordinary skill in the art. For example, surfactants may include HYDROPALAT 44, commercially available from BASF Corporation; and DYNOL 607, commercially available from Air Products (Allentown, Pa.). Defoamers may include multi-hydrophobe blend defoamers and other defoamers known to those of ordinary skill in the art. For example, defoamers may include FOAMASTER SA-3, commercially available from BASF Corporation. Ammonia compositions may include ammonium hydroxide, for example, AQUA AMMONIA 26 BE, commercially available from Tanner Industries, Inc. (Southampton, Pa.). Biocides may include broad-spectrum microbicides that prohibit bacteria and fungi growth, antimicrobials such as those based on the active diiodomethyl-p-tolylsulfone, and other compounds known to those of ordinary skill in the art. For example, biocides may include KATHON LX 1.5%, commercially available from Dow Chemical Company, POLYPHASE 663, commercially available from Troy Corporation (Newark, N.J.), and AMICAL Flowable, commercially available from Dow Chemical Company. Biocides may also act as preservatives. UV absorbers may include encapsulated hydroxyphenyl-triazine compositions and other compounds known to those of ordinary skill in the art, for example, TINUVIN 477DW, commercially available from BASF Corporation. Transfer agents such as polyvinyl alcohol (PVA) and other compounds known to those of ordinary skill in the art may also be included in the coating composition.

### Panels and Systems

Gypsum panels having improved fire resistance and/or physical properties may be made by any of the methods described herein. For example, a gypsum panel may include a gypsum core containing set gypsum and a colloidal material including colloidal silica, colloidal alumina, or both, wherein the colloidal material is present in the gypsum core in an amount greater than any other component, other than the gypsum. As discussed above, the panels may have a thickness from about ¼ inch to about 1 inch. For example, the panels may have a thickness of from about ½ inch to about ⅝ inch.

In certain embodiments, one or both face layers 108, 110 are a nonwoven fiberglass mat. For example, the glass fibers may have an average diameter of from about 10 to about 17 microns and an average length of from about ¼ inch to about 1 inch. For example, the glass fibers may have an average diameter of 13 microns (i.e., K fibers) and an average length of ¾ inch. In certain embodiments, the nonwoven fiberglass mats have a basis weight of from about 1.5 pounds to about 6.0 pounds per 100 square feet of the mat, such as from about 1.5 pounds to about 3.5 pounds per 100 square feet of the mat. The mats may each have a thickness of from about 20 mils to about 35 mils. The fibers may be bonded together to form a unitary mat structure by a suitable adhesive. For example, the adhesive may be a urea-formaldehyde resin adhesive, optionally modified with a thermoplastic extender or cross-linker, such as an acrylic cross-linker, or an acrylate adhesive resin. In other embodiments, the mat facer may be a suitable paper facer material.

In some embodiments, the gypsum core 102 is present in an amount from about 5 percent to about 20 percent, by weight, of the gypsum layers 101.

In certain embodiments, one or more of the gypsum layers 101 also include reinforcing fibers, such as chopped fiberglass fibers or particles. In one embodiment, the gypsum core contains about 1 pound to about 20 pounds of reinforcing fibers per 1000 square feet of panel. For example, the gypsum core, or any layer(s) thereof, may include up to about 6 pounds of reinforcing fibers per 1000 square feet of panel. For example, the gypsum core, or a slate coat layer, may include about 3 pounds of reinforcing fibers per 1000 square feet of panel. The reinforcing fibers may have a diameter between about 10 and about 17 microns and have a length between about 5 and about 18 millimeters.

A further embodiment is a method of making a gypsum panel, comprising:
i) providing a slate coat slurry comprising stucco, water, and a formaldehyde scavenger;
ii) providing a face layer; and
iii) setting the slate coat slurry on the face layer to form a slate coat layer of the gypsum panel.

In certain embodiments, the method further comprises
iv) providing a gypsum core slurry comprising stucco and water; and
v) setting the gypsum core slurry on the slate coat slurry to form a gypsum core layer.

In certain embodiments, the method further comprises
vi) providing a second face mat layer; and
vii) placing the second face layer on said gypsum core slurry.

In certain embodiments, the method further comprises
vi) providing a second slate coat slurry, comprising stucco, water, and optionally a formaldehyde scavenger;
vii) setting the second slate coat slurry on the gypsum core slurry to form a second slate coat layer;
viii) providing a second face mat layer; and
ix) placing the second face layer on said second slate coat slurry.

The disclosed subject matter is further described in the following non-limiting Examples. It should be understood that these Examples, while indicating preferred embodiments of the subject matter, are given by way of illustration only.

### EXAMPLES

### Example 1: Manufacturing Testing

The first test was based on a standard manufacturing process, to determine how urea scavenger reduced formaldehyde emissions during curing of a gypsum panel according to the embodiment of the invention depicted in FIG. 1A. For each embodiment tested, a glass mat was laid on a surface inside of a closed caul, and, in order, a first slate coat slurry, a gypsum core slurry, and the second slate coat slurry, again, were applied to the top surface. A second glass mat was then applied to the top of the second slate coat slurry. The assembled, uncured board was then cured in an oven at 480° F. for 20 minutes. The air in the oven traveled through impinger tubes. The samples collected were then analyzed using a liquid chromatography (LC) column, into a detector, where the amount of formaldehyde was quantified.

### Example 2: Finished Product Testing

The GreenGuard Gold testing protocol was used to assess formaldehyde emissions in the finished, cured gypsum panel, and to simulate the environment once a gypsum panel is installed. The testing was conducted according to UL 2821 Standard using ASTM D6196 and D5197 methods. For sample preparation, the finished panel was placed in a Mylar® (Biaxially-oriented polyethylene terephthalate) polyester bag after two hours kept under ambient conditions. The samples were then analyzed via the above ASTM method where the face surface (i.e., the glass mat side) was exposed to analyze and quantify the formaldehyde levels.

The results from Experiments 1 and 2, comparing emissions from the urea-treated gypsum panels to those from boards without any urea added, are shown in Table 1, below. Urea solution was prepared in water 40 to 60% and then added to the slurry or slate coat and other experiments conducted. For mat spray also used the same concentration of urea solution. Each value represents the average of approximately 5 tests, using urea loadings of 4-22 lb/msf in each identified portion of the gypsum panel:

TABLE 1
Formaldehyde emissions from urea-treated
gypsum panels compared to control

| | Manufacturing test | Product test |
|---|---|---|
| Sample | % reduction | % reduction |
| Control | n/a | n/a |
| Urea in glass mat (Applied as | 60-70% | >95% |
| a coating on the outside only) | | |
| Urea in glass mat (Applied as | 70-80% | >95% |
| a spray on both sides of the | | |
| mat) | | |
| Urea in slate coat and glass | ~80% | >90% |
| mat | | |
| Urea in slate coat only | 40-50% | 60-90% |
| Urea in core only | 20-30% | Not tested |

### Example 3: Strength and Curing Tests

Urea was added to a gypsum slurry to determine if the addition of urea would negatively impact the strength, or curing profile, of the slurry using a thermocouple.

The formulations with gypsum and other additives with urea were analyzed. The results of the strength testing are shown in Table 2, below:

TABLE 2
Compressive strength of urea-treated slurries

| | Average cube | Average cube compressive |
|---|---|---|
| | weight (g) | strength (lbF) |
| Control | 100 | 3000 |
| Urea (10 lb/msf) | 99 | 3021 |
| Urea (20 lb/msf) | 101 | 3103 |

As can be seen in the data above, the introduction of urea into the slurry did not reduce the strength of the cured slurry, and in fact increased it, particularly when added at 20 lb/msf.

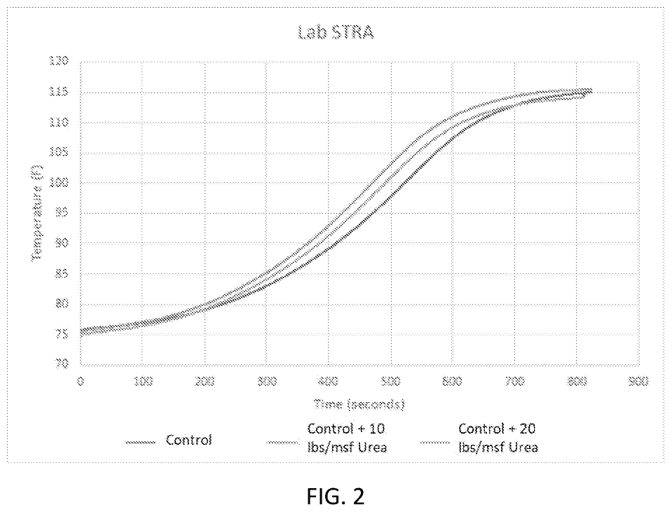

The curing profiles for each of the three slurries are shown in FIG. 2. The slurries were left to cure at room temperature, and a thermocouple was placed in the slurry. As the curing reaction is exothermic, the amount and rate of temperature increase correlates to the degree and rate of curing. As seen in FIG. 2, all three slurries reached peak curing at approximately the same time, indicating that there was no significant effect on curing caused by the addition of urea.

A pour consistency test was also performed, on slurries both with and without urea. A fixed amount of the slurry was poured onto a location and allowed to settle into a circle. The size of the resulting circle was then recorded. There was no evident change in consistency from the addition of urea, and results were similar to the control sample.

### Example 4: Samples with Urea Scavenger in Slate Coat

The gypsum panels were prepared using urea scavengers (50% solution in water) in the slate coat layer 2 lb/msf to 16 lb/msf. Either incorporating only in one slate coat or distributing them between the face slate coat and back slate coats (for example 8 lb/msf and 8 lb/msf in the face and back slate coats to achieve total 16 lbs/msf). Can also be present in different concentrations to achieve total or about 2 lb/msf to 16 lb/msf. In a particular prototype the boards were made with 4 lb/msf in face and 4 lb/msf in back slate coat layer or slurry. Once prepared, the boards were analyzed via both manufacturing testing method as wet boards and the finished product testing. Closed caul testing showed 50% formaldehyde reduction and Green Guard Gold test showed up to 90% reduction of formaldehyde vs a control sample lacking the urea.

### Example 5: Samples with Urea Scavenger as a Gradient Through Board Thickness

Gypsum panels were prepared using urea scavengers (50% solution in water) in the slate coat layer combined with the glass mat face and back. 2 lb/msf to 22 lb/msf. Either incorporating only in one slate coat or distributing them between the face slate coat and back slate coats, plus face glass mat (like 8 lb/msf and 8 lb/msf in slate coats and on top 6 lb/msf in the face mat for a total of 22 lbs/msf). In a particular prototype the boards were made with 4 lb/msf in the face and 4 lb/msf in back slate coat layer or slurry. On top, 6 lb/msf was sprayed on the bonded side if the glass mat. The boards, once made, were analyzed via both manufacturing testing method and the finished product testing. Closed caul testing showed ˜70% formaldehyde reduction and Green Guard Gold test showed >90% reduction of formaldehyde vs control sample.

Many modifications and other embodiments of the subject matter set forth herein will come to mind to one skilled in the art to which the subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation. Each embodiment disclosed herein is contemplated as being applicable to each of the other disclosed embodiments. All combinations and sub-combinations of the various elements described herein are within the scope of the embodiments.

1-92. (canceled)

93. A gypsum panel, said panel comprising:
i) a first face layer;
ii) a second face layer;
iii) a gypsum core layer, interposed between the first face layer and the second face layer; and
iv) a first slate coat layer, interposed between the gypsum core layer and the first face layer;
wherein at least one slate coat layer comprises urea.

94. The gypsum panel of claim 93, further comprising a second slate coat layer interposed between the gypsum core layer and the second face layer.

95. The gypsum panel of claim 93, wherein said slate coat layer comprises urea in an amount from about 0.5 to about 50 lb/msf, for a gypsum panel having a thickness of about ¼ inch to about 1 inch.

96. The gypsum panel of claim 94, wherein said first slate coat layer and said second slate coat layer both comprise a formaldehyde scavenger.

97. The gypsum panel of claim 93, wherein urea is also present in the gypsum core layer.

98. The gypsum panel of claim 93, wherein the gypsum core is free of urea.

99. The gypsum panel of claim 93, wherein a formaldehyde scavenger is present in at least one face layer.

100. The gypsum panel of claim 99, wherein said face layer is a glass mat; said glass mat comprising
i) glass fibers;
ii) a resin binder; and
iii) a mat coating;
wherein said formaldehyde scavenger is present in said resin binder and/or said mat coating.

101. The gypsum panel of claim 100, further comprising a coating on at least one of said face layers; wherein said coating comprises urea.

102. The gypsum panel of claim 93, wherein the gypsum panel emits from about 1% to about 99% fewer formaldehyde emissions, as compared to an otherwise identical gypsum panel that does not comprise the formaldehyde scavenger.

103. A method of making a gypsum panel, comprising:
i) providing a slate coat slurry comprising stucco, water, and urea;
ii) providing a face layer; and
iii) setting the slate coat slurry on the face layer to form a slate coat layer of the gypsum panel.

104. The method of claim 103, further comprising
iv) providing a gypsum core slurry comprising stucco and water; and
v) setting the gypsum core slurry on the slate coat slurry to form a gypsum core layer.

105. The method of claim 104, further comprising
vi) providing a second face mat layer; and
vii) placing the second face layer on said gypsum core slurry.

106. The method of claim 104, further comprising
vi) providing a second slate coat slurry, comprising stucco, water, and optionally urea;
vii) setting the second slate coat slurry on the gypsum core slurry to form a second slate coat layer;
viii) providing a second face mat layer; and
ix) placing the second face layer on said second slate coat slurry.

107. The method of claim 104, wherein said first slate coat slurry and said second slate coat slurry both comprise urea.

108. The method of claim 103, wherein urea is also present in the gypsum core slurry.

109. The method of claim 103, wherein the gypsum core slurry is free of urea.

110. The method of claim 103, wherein a formaldehyde scavenger is present in at least one face layer.

111. The method of claim 103, wherein:
said face layer is a glass mat; and
said glass mat comprises:
i) glass fibers;
ii) a resin binder; and
iii) a mat coating;
wherein said formaldehyde scavenger is present in said resin binder and/or said mat coating.

112. The method of claim 103, further comprising applying a coating on an exterior surface of at least one of said face layers; wherein said coating comprises a formaldehyde scavenger.

113. A gypsum panel made by the method of claim 103.

114. The gypsum panel of claim 93, wherein said formaldehyde scavenger is selected from the group consisting of urea, amine derivatives, polymers with amine groups, and polyamines.
